(19) United States
(12) Patent Application Publication
(10) Pub. No.: US 2021/0295211 A1
(43) Pub. Date: Sep. 23, 2021

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Takehito WATANABE, Kanagawa (JP)

(73) Assignee: FUJIFILM BUSINESS INNOVATION CORP., Tokyo (JP)

(21) Appl. No.: 17/022,655

(22) Filed: Sep. 16, 2020

(30) Foreign Application Priority Data
Mar. 23, 2020 (JP) 2020-051541

(51) Int. Cl. G06N 20/00; G06N 7/00

(52) U.S. Cl. CPC G06N 20/00; G06N 7/005

(57) ABSTRACT

An information processing apparatus includes a memory storing a document file created for cases or a message collection related to the cases and exchanged among multiple users, and a processor configured to extract information on a target case from the document file or the message collection stored on the memory, and predict a conclusion of the target case from the extracted information using artificial intelligence that has learned through machine learning to predict the conclusion of the target case in accordance with information on the document file or the message collection on each case.

### CROSS-REFERENCE TO RELATED APPLICATIONS

This application is based on and claims priority under 35 USC 119 from Japanese Patent Application No. 2020-051541 filed Mar. 23, 2020.

### BACKGROUND

### (i) Technical Field

The present disclosure relates to an information processing apparatus and a non-transitory computer readable medium.

### (ii) Related Art

Japanese Patent No. 5759406 discloses a system that assists sales of life insurance. The system includes a contact amount acquisition unit, information amount acquisition unit, and a probability determination unit.

The contact amount acquisition unit acquires for each customer a contact amount that is the number of contacts a sales person has contacted a potential customer. The information amount acquisition unit acquires an amount of information related to the potential customer that the sales person has collected from the potential customer. The probability determination unit determines a probability of establishment of a contract with the potential customer in accordance with the contact amount and the information amount.

The contact amount acquisition unit acquires a first contact amount that is the number of contacts that the sales person has interviewed the potential customer and a second contact amount that the sales person has contacted the potential customer without meeting in person. If the first contact amount is equal to or above a first specific value, the probability determination unit determines a first probability in response to the first contact amount.

If the first contact amount is below the first specific value and the second contact amount is equal to or above a second specific value, the probability determination unit determines in accordance with the information amount a second probability that is lower than the first probability. If the first contact amount is below the first specific value and the second contact amount is below the second specific value, the probability determination unit determines in accordance with the second contact amount a third probability that is below the second probability.

Japanese Patent No. 6224982 discloses an order judgement visualization apparatus that facilitates an objective determination about success or failure in receiving an order in accordance with quality of contacts of sales section with a potential customer and effort the sales section has made with the potential customer.

The order judgement visualization apparatus includes a contact point memory, effort score memory, customer specifying unit, item specifying unit, date input unit, item date memory, and customer selection unit. The contact point memory stores, in an associated form, a contact item indicating the quality of a contact and an evaluation score of the contact item. The effort score memory stores, in an associated form, an effort item indicating effort contents and an evaluation score of the effort item. The customer specifying unit specifies a customer. The item specifying unit specifies the contact item or the effort item. The date input unit inputs date on which a contact related to a contact item specified by the item specifying has been made or has been no longer made with the customer specified by the customer specifying unit or date on which an effort related to an effort item has been made with the customer specified by the customer specifying unit. The item date memory stores for each customer in an associated form the item specified by the item specifying unit and the date input by the date input unit. The customer selection unit selects a customer.

The order judgement visualization apparatus further includes a graph creation unit and a graph display. Based on the information stored on the item date memory and the evaluation score stored on the contact point memory or the effort score memory, with respect to the customer selected by the customer selection unit, the graph creation unit creates a quality graph indicating a time-series change in the evaluation score of the contact item, an effort graph indicating a time-series change in the evaluation score of the effort item, and an aggregate graph indicating a time-series change in the evaluation scores of the contact item and the effort item. The graph display displays the three graphs, created by the graph creation unit, on the same screen with a common time axis and a common score axis drawn thereon.

In the system that predicts the conclusion of a case in terms of success or failure, a person in charge enters information on a predetermined item and a document created for the case has not been used.

### SUMMARY

Aspects of non-limiting embodiments of the present disclosure relate to an information processing apparatus and a non-transitory computer readable medium for using a document file created for a case or a message collection exchanged among multiple users concerning the case when the conclusion on the case in terms of success or failure is predicted.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a memory storing a document file created for cases or a message collection related to the cases and exchanged among multiple users, and a processor configured to extract information on a target case from the document file or the message collection stored on the memory, and predict a conclusion of the target case from the extracted information using artificial intelligence that has learned through machine learning to predict the conclusion of the target case in accordance with information in the document file or the message collection on each case.

### BRIEF DESCRIPTION OF THE DRAWINGS

Exemplary embodiment of the present disclosure will be described in detail based on the following figures, wherein:

FIG. 1 illustrates a conceptual modular configuration of an exemplary embodiment;

FIG. 2 illustrates a system configuration of the exemplary embodiment;

FIG. 3 illustrates a detailed modular configuration of the exemplary embodiment;

FIG. 4 is a flowchart illustrating a process example of the exemplary embodiment;

FIG. 5 is a flowchart illustrating a process example of the exemplary embodiment;

FIG. 6 is a flowchart illustrating a process example of the exemplary embodiment;

FIG. 7 illustrates a data structure of a document file management table;

FIG. 8 illustrates a data structure of a message management table;

FIG. 9 illustrates a data structure of an information element extraction setting management table;

FIG. 10 illustrates a process example of the exemplary embodiment;

FIG. 11 illustrates a data structure of a message loop management table;

FIG. 12 illustrates a process example of the exemplary embodiment;

FIG. 13 illustrates a data structure of a prediction and conclusion management table;

FIG. 14 illustrates a data structure of a document file order management table;

FIG. 15 illustrates an example of order and time intervals of a document file provided to a partner user; and

FIGS. 16A and 16B illustrate a data structure of an information element extraction setting management table.

### DETAILED DESCRIPTION

Exemplary embodiment of the disclosure is described with reference to the drawings.

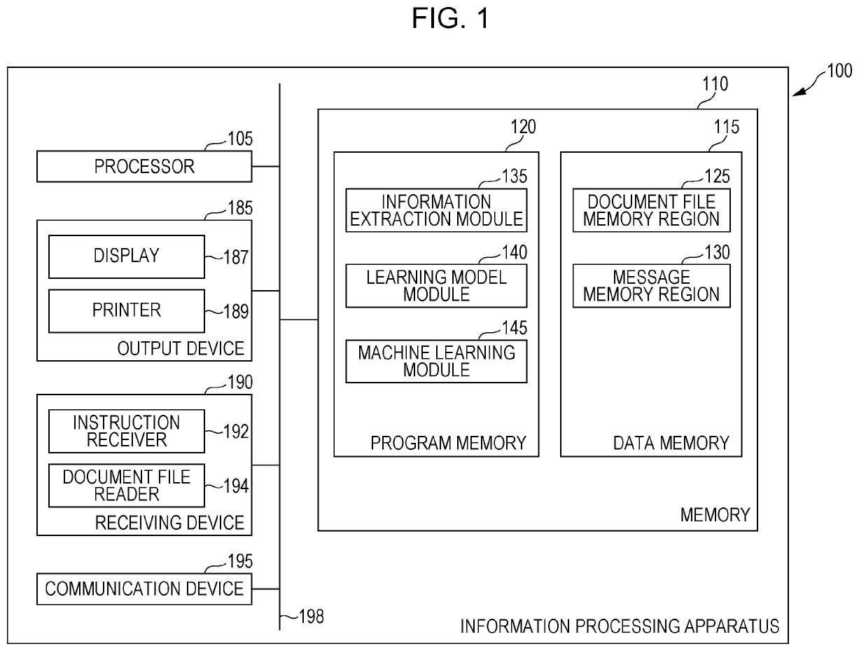

FIG. 1 illustrates a conceptual modular configuration of the exemplary embodiment. The term “module” refers to a software component (including a computer program) that is logically separable, or a hardware component. The module of the exemplary embodiment refers to not only a module in a computer program but also a module in a hardware configuration. The discussion of the exemplary embodiment also serves as the discussion of a system, method, and computer programs for causing the modules to function (including a program that causes a computer to execute each step, a program that causes the computer to function as an element, and a program that causes the computer to implement each function). In the discussion that follows, the phrases “stores information,” “causes information to be stored,” and other phrases equivalent thereto are used. If the exemplary embodiment is a computer program, these phrases are intended to express “causes a memory device to store information” or “controls a memory device to cause the memory device to store information.” The modules may correspond to the functions in a one-to-one correspondence. In software implementation, one module may be configured of one program or multiple modules may be configured of one program. One module may be configured of multiple programs. Multiple modules may be executed by a single computer. A single module may be executed by multiple computers in a distributed environment or a parallel environment. One module may include another module.

In the discussion that follows, the term “connection” refers to not only a physical connection but also a logic connection (such as an exchange of data, instructions, data reference relationship, or login).

The term “predetermined” means that something is decided in advance of a process of interest. The term predetermined is thus intended to refer to something that is decided in advance of a process of interest in the exemplary embodiment. Even after a process in the exemplary embodiment has started, the term predetermined refers to something that is decided in advance of a process of interest depending on a condition or a status of the exemplary embodiment at the present point of time or depending on a condition or status of the exemplary embodiment heretofore continuing down to the present point of time. If plural predetermined values are used, the predetermined values may be different from each other, or two or more of the predetermined values (including all the values) may be equal to each other.

A statement that “if A, B is to be performed” is intended to mean that it is determined whether something is A, and that if something is determined as A, an action B is to be taken. The statement becomes meaningless if the determination as to whether something is A is not performed. If a discussion is made of events “A, B, and C,” the discussion is applicable to at least one of the events “A, B, and C” unless otherwise noted. For example, the discussion is applicable to the case in which only the event A is selected.

The term “system” and the term “apparatus” refer to an arrangement where multiple computers, a hardware configuration, and an apparatus are interconnected via a communication network (including a one-to-one communication connection). The term system and the term apparatus also refer to an arrangement that includes a single computer, a hardware configuration, and an apparatus. The term system and the term apparatus have the same definition and are interchangeable with each other. The system in the context of the exemplary embodiment does not include a social system that is a social arrangement formulated by humans.

At each process performed by a module, or at one of the processes performed by a module, information as a process target is read from a memory device, the information is then processed, and the process results are written onto the memory device. A description related to the reading of the information from the memory device prior to the process and the writing of the processed information onto the memory device subsequent to the process may be omitted as appropriate.

An information processing apparatus 100 of the exemplary embodiment has a function of predicting the conclusion of a case in terms of success or failure. Referring to FIG. 1, the information processing apparatus 100 includes at least a processor 105 and memory 110 and further includes a bus 198 through which data is exchanged therebetween. The information processing apparatus 100 may further include an output device 185, receiving device 190, and communication device 195. Data is exchanged via the bus 198 among the processor 105, memory 110, output device 185, receiving device 190, and communication device 195.

The block diagram in FIG. 1 also illustrates a hardware configuration of a computer that implements the exemplary embodiment. The computer hardware executing a program of the exemplary embodiment is a computer illustrated in FIG. 1 and is typically a computer, such as a personal computer or server. Specifically, the information processing apparatus 100 employs the processor 105 and the memory 110 as a storage device.

One or more processors 105 may be employed. The processor 105 may include a central processing unit (CPU) or a microprocessor. If multiple processors 105 are employed, they may be a tightly or loosely coupled multiprocessor. For example, a single processor 105 may include multiple processor cores. Alternatively, a system including multiple computers linked via a communication network and functioning like a virtual single computer may be employed. The system may be a loosely coupled multiprocessor that is constructed as a cluster system or a computer cluster. The processor 105 executes a program on the program memory 120.

The memory 110 may include a semiconductor memory, such as a register or a cache memory in the processor 105 or a memory, such as a random-access memory (RAM) or a read-only memory (ROM). The memory 110 may also be an internal memory device, such a hard disk drive (HDD) or a solid-state drive (SSD), each functioning as a persistent memory, or an external memory device or an auxiliary memory device, such as a compact disc (CD), or digital versatile disc (DVD), Blu-ray (registered trademark) disc, universal serial bus (USB) memory, memory card or other external storage device or other auxiliary memory device. The memory 110 may also be a memory device of a server connected to the information processing apparatus 100 via a communication network.

The memory 110 includes a data memory 115 storing data and a program memory 120 storing programs. The program memory 120 and the data memory 115 may store programs of the modules illustrated in FIG. 1, programs such as an operating system to start up the computer, and data, such as parameters that appropriately vary in the execution of the modules.

The output device 185 includes a display 187 and printer 189. The display 187 may be a liquid-crystal display, organic electroluminescent (EL) display, or three-dimensional display and displays, in text or image, process results from the processor 105 and data on the data memory 115. The printer 189 may be a printer or a multi-function device and prints the process results from the processor 105 and data on the data memory 115. The output device 185 may also include a speaker and actuator to vibrate the device.

The receiving device 190 includes an instruction receiver 192 and document file reader 194. The instruction receiver 192 is a keyboard, mouse, microphone, camera (including eye-gaze detection camera) or other devices. The instruction receiver 192 receives data (manual operation, voice, or gaze) that is based on user operation performed on one of these devices.

A touch screen serving the functions of both the display 187 and the instruction receiver 192 may be used. In such a case, without the physical presence of keys, the keyboard function may be implemented by drawing a keyboard (called a software keyboard or a screen keyboard) on the touch screen using software.

The display 187 and instruction receiver 192 are used as a user interface.

The document file reader 194 serving as a scanner or camera receives, as a document file, image data that is generated by reading or photographing a document.

The communication device 195 is a communication network interface used to connect to another apparatus via a communication network.

The exemplary embodiment related to computer program is implemented when the computer program as a software resource is read onto the program memory 120 as a hardware resource and the software and hardware resources cooperate with each other.

The hardware configuration in FIG. 1 is illustrated for exemplary purposes only. The exemplary embodiment is not limited to the configuration illustrated in FIG. 1 and is acceptable as long as the configuration implements the modules of the exemplary embodiment. For example, the processor 105 may include a graphics processing unit (GPU) (including general-purpose computing on graphics processing unit (GPGPU)). The processor 105 may be a dedicated hardware resource (such as application specific integrated circuit (ASIC)) that executes part of the modules or field-programmable gate array (FPGA) that is reconfigurable integrated circuit. Part of the modules may be in an external system that is connected to the information processing apparatus 100 via a communication network. Multiple of the system in FIG. 1 may be operatively coupled via a communication network. The system in FIG. 1 may be incorporated in a personal computer, portable information communication apparatus (such as cellular phone, smart phone, mobile device, or wearable computer), information appliance, robot, copier, fax, scanner, printer, or multi-function apparatus (an image processing apparatus having at least two of scanner function, printer function, copier function, and fax function).

The processor 105 is connected to the memory 110, output device 185, receiving device 190, and communication device 195 via the bus 198. The processor 105 executes a process in accordance with the computer program that describes an execution sequence of each module and stored on the program memory 120. For example, when the instruction receiver 192 receives a user operation, the processor 105 performs the process of a module on the program memory 120 corresponding to the user operation, causes the data memory 115 to store the process results, outputs the process results to the display 187, or transmits the process results to another apparatus via the communication device 195.

The memory 110 includes the data memory 115 and program memory 120 and is connected to the processor 105, output device 185, receiving device 190, and communication device 195 via the bus 198.

The data memory 115 includes a document file memory region 125 and message memory region 130.

The document file memory region 125 stores a document file created for a case. The document file stored may include not only the document file but also meta information described below.

The “case” is a case that is to be processed and related to several persons including one who makes or applies a proposal and another who makes a conclusion about the case. For example, the person who makes a proposal may be a sales person and the person who makes a conclusion about the case may be a customer. Each case ends with a final conclusion. The final conclusion may include success or failure in the case, granted or denied, or pass or fail.

The case may be understood as a series of activities that are likely to lead to a conclusion. In the communications using a collaboration tool, a series of activities are performed with multiple groups (also called rooms) set up. In the context of the exemplary embodiment, a unit, such as a room in the collaboration tool, corresponds to a case.

The message memory region 130 stores a message collection exchanged about the case among multiple users. The stored message may include not only the message but also meta information described below.

The message collection exchanged about the case among multiple users may not necessarily mean the message collection exchanged among all the users but may mean the message collection exchanged among of some of the users.

The document file or the message collection stored on the document file memory region 125 or the message memory region 130 is a target from which the information extraction module 135 retrieves a character string. The document file or the message collection may include a character string that is contents of the document file, a character string that is contents of the message collection, and the meta information attached to the document file or the message collection. The meta information is information other than the contents of the document file or the message collection and does not form the document file or the message collection. For example, the meta information of the document file may include a file name, date of registration, and name of a creator. The meta information of the message collection may include a date of transmission of the message, sender, receiver, the number of characters in the message, contents of the document file attached to the message, and the meta information on the attached document file.

The program memory 120 stores an information extraction module 135, learning model module 140, and machine learning module 145.

The information extraction module 135 extracts information on a target case from the document file or the message collection stored on the data memory 115. The extraction may be performed in accordance with a predetermined rule. Multiple rules may be used to extract a single piece of information.

The information extraction module 135 may divide the message collection stored on the message memory region 130 into a series of exchanges and extract information for each exchange.

The series of exchanges indicates a first to last messages exchanged about a given subject among multiple persons. For example, if a time period with no messages exchanged continues for a predetermined duration of time (specifically, the duration of time throughout which no messages are exchanged), the series of exchanges may be determined to be complete. Predetermined key words, if found, may be determined to indicate the first and last of the exchanging. For example, the character string “First, let's discuss . . . ,” if found, is determined to be an initiation of the exchanging and the character string “This completes . . . ,” if found, is determined to indicate the end of the exchanging. The message collection between the initiation and the end may be considered “a series of exchanges.”

The information extraction module 135 may link at least two pieces of information of when, where, who, what, why, and how as the information to be extracted from the series of the exchanges and input the information to the learning model module 140 for prediction.

The words when, where, who, what, why, and how (five W's and one H) may be extracted through language processing such as morphological analysis.

In artificial intelligence, learning is performed using teacher data that is created by linking at least two pieces of information of when, where, who, what, why, and how.

The information extraction module 135 may extract multiple different types of information in accordance with multiple different types of rules and may select a type of information to be input to the learning model module 140 using a prediction accuracy corresponding to each type of information extracted.

If the information processing apparatus 100 reaches a finalized conclusion about the case, the extraction information and the conclusion are stored in an associated form. For example, there may be information A that has been extracted more frequently in a successful case having reached contract signing and information B that has been extracted more frequently in an unsuccessful case having failed to reach contract signing. The information A is set to be higher in prediction accuracy than the information B. In this case, the information A is selected and used in prediction using artificial intelligence.

The information extraction module 135 may retrieve from an external information processing apparatus second information related to the extracted information. The extracted information and the second information may be stored on the learning model module 140 in an associated form.

The second information related to the extracted information may be information indicating the scale of customers. For example, the scale of customers (customer company) may be the capital amount of the customer company and the number of employees of the customer company. The scale of customer may be a case phase or the number of contacts to a person in charge of the customer company.

The information extraction module 135 may extract a sequential order or time intervals at which the extracted information has been provided to the customer. The extracted information and the sequential order or time intervals may be input in an associated form to the learning model module 140.

The sequential order of providing the extracted information may be fixed. If the information that would be typically provided at a final stage is provided at an initial stage, the probability of the successful case is likely to be higher. The probability of the successful case is likely to be higher at shorter time intervals at which the extracted information is provided than at longer time intervals. For this reason, the artificial intelligence is used with the information associated with the sequential order or the time intervals.

In the artificial intelligence, learning is performed using teacher data where information is associated with a sequential order or time intervals at which the information is provided.

The learning model module 140 predicts the conclusion of the target case from the information extracted by the information extraction module 135. The learning model module 140 has learned beforehand through machine learning to predict the conclusion of the case corresponding to information in a document file or a message collection corresponding to each case. The conclusion may be two values, such as “singing a contract” and “not signing a contract,” or may be a case success probability that indicates a rate of successful contract. The conclusion may be a case failure probability that indicates a rate of unsuccessful contract.

The learning model module 140 may receive in an associated form the information extracted by the information extraction module 135 and the second information and predict the conclusion of the target case.

The learning model module 140 may receive in an associated form the information extracted by the information extraction module 135 and the sequential order or time intervals and predict the conclusion of the target case.

The machine learning module 145 has learned beforehand through machine learning to predict the conclusion of the case corresponding to information in the document file or the message collection corresponding to each case and creates the learning model module 140. For example, the machine learning module 145 creates the learning model module 140 through machine learning using teacher data. Concerning a past case with a determined conclusion, the teacher data is a set of the conclusion of the case and the document file created for the case or the message collection exchanged about the case among users. The machine learning is a technique of automatically learning a model that sorts unknown data from a set of data into several predefined categories. For example, the machine learning may be decision tree, Naïve Bayes model, decision list, support vector machine, maximum entropy method, conditional random field, convolutional neural network, or recurrent neural network.

The learning model module 140 created by the machine learning module 145 may thus predict a target conclusion from information on multiple factors. The target conclusion is a result of the case. The machine learning module 145 may perform machine learning improves the prediction accuracy by checking prediction results with the conclusion of the case.

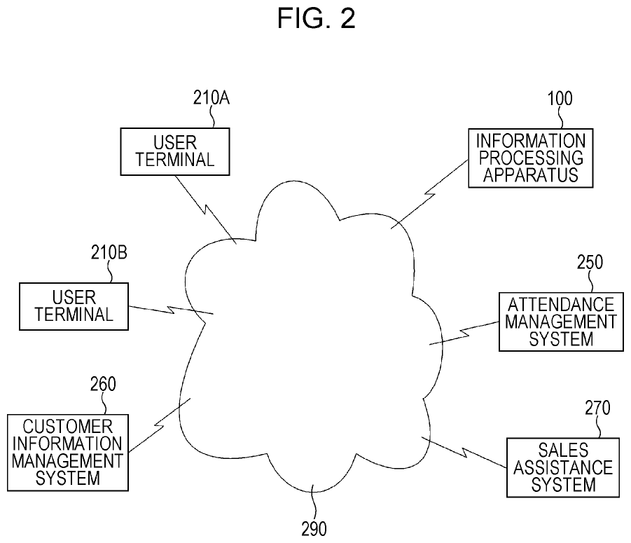

FIG. 2 is a system configuration of the exemplary embodiment. The information processing apparatus 100, user terminal 210A, user terminal 210B, attendance management system 250, customer information management system 260, and sales assistance system 270 are connected to each other via a communication network 290. The communication network 290 may be a wireless network, a wired network, or a combination thereof. The communication network 290 may be a communication infrastructure, such as the Internet or intranet. The function of the information processing apparatus 100 may be implemented as a cloud service.

Using a user terminal 210, a user as a sales person creates a document file to be provided to a customer about a certain case. The user exchanges messages with the customer, the user's superior, and colleagues to sign a contract for the case. For example, messages are exchanged via a collaboration tool and document files may be accumulated.

Using the information processing apparatus 100, the user or user's superior may now wish to predict whether the case can be signed.

A file-management type collaboration tool handles a document file. A chat type collaboration tool handles a message and a document file attached thereto. Not only the collaboration tool but also a bulletin board system and a message function of social networking service (SNS) may be used.

The information processing apparatus 100 extracts information in accordance with a predetermined rule from the document file created for the target case or the message collection. Through the artificial intelligence having performed machine learning, the information processing apparatus 100 predicts whether the case can be signed and presents the prediction results to the user or user's superior who is a requester. The machine learning uses as the teacher data a set of information that is extracted in accordance with the rule from the conclusion of the past case and the document file created for the case or the message collection.

When the prediction is performed, the user is not requested to enter new information. Specifically, the prediction is performed using the document file created for the case and the message collection exchanged about the case. The information processing apparatus 100 is thus free from entering new information for prediction.

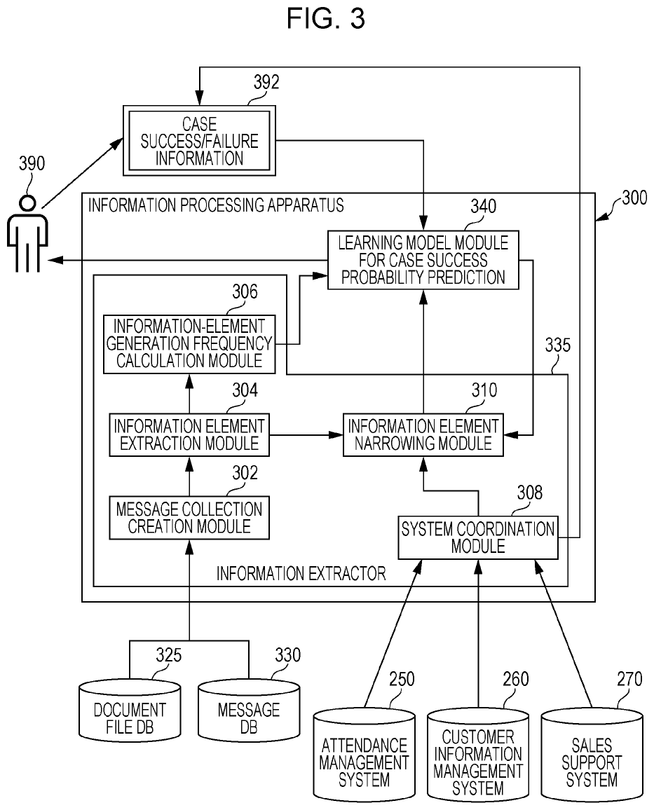

FIG. 3 illustrates a detailed modular configuration of the exemplary embodiment. An information processing apparatus 300 includes an information extractor 335 and learning model module 340 for case success probability prediction.

The information extractor 335 includes a message collection creation module 302, information element extraction module 304, information element generation frequency calculation module 306, system coordination module 308, and information element narrowing module 310.

The message collection creation module 302 is connected to the information element extraction module 304, document file database (DB) 325 and message DB 330.

The information element extraction module 304 is connected to the message collection creation module 302, information element generation frequency calculation module 306, and information element narrowing module 310.

The information element generation frequency calculation module 306 is connected to the information element extraction module 304 and learning model module 340 for case success probability prediction.

The system coordination module 308 is connected to the information element narrowing module 310, attendance management system 250, customer information management system 260, sales assistance system 270, and case success/failure information 392.

The information element narrowing module 310 is connected to the information element extraction module 304, system coordination module 308, and learning model module 340 for case success probability prediction.

The document file DB 325 is connected to the message collection creation module 302.

The message DB 330 is connected to the message collection creation module 302.

The learning model module 340 for case success probability prediction is connected to the information element generation frequency calculation module 306, information element narrowing module 310, user 390, and the case success/failure information 392.

The attendance management system 250, customer information management system 260, and sales assistance system 270 are connected to the system coordination module 308.

The information extractor 335 corresponds to the information extraction module 135 in the information processing apparatus 100. The learning model module 340 for case success probability prediction corresponds to the learning model module 140 and machine learning module 145 in the information processing apparatus 100. The document file DB 325 corresponds to the document file memory region 125 in the information processing apparatus 100. The message DB 330 corresponds to the message memory region 130 in the information processing apparatus 100.

The case success/failure information 392 indicates whether the case has been signed or not. The information processing apparatus 300 acquires the case success/failure information 392 in response to an input manually entered by the user 390 or the information element extraction module 304.

The message collection creation module 302 aggregates, as the message collection, multiple messages related to an exchange about the case in the messages on the message DB 330.

The information element extraction module 304 extracts an information element from messages and document files (including a document file attached to a message) on the message DB 330 and the document file DB 325. The information element is extracted from a target message or document file in accordance with a predetermined rule. The rule is predetermined to extract the information element that may possibly be related to the conclusion of the case. Multiple different types of information elements (hereinafter referred to as information element types) are extracted in accordance with multiple rules. Multiple rules may be predetermined to extract a single information element type.

The information element narrowing module 310 narrows information elements that are transferred to the learning model module 340 for case success probability prediction such that the case success probability is at a higher accuracy level. The information element narrowing module 310 may not necessarily be employed and the information element extracted by the information element extraction module 304 may be directly transferred to the learning model module 340 for case success probability prediction.

The information element generation frequency calculation module 306 calculates a generation frequency of the information element using generation time information on the information element and type information on the information element. The information element generation frequency calculation module 306 may not necessarily be employed and the learning model module 340 for case success probability prediction may predict the success probability without using the generation frequency on the information element.

The learning model module 340 for case success probability prediction predicts the case success probability from the information element extracted by the information element extraction module 304. The information elements narrowed by the information element narrowing module 310 may be used. The generation frequency on the information element extracted by the information element generation frequency calculation module 306 may further be used in the prediction.

The learning model module 340 for case success probability prediction improves the prediction accuracy by performing machine learning further using the case success/failure information 392.

The document file DB 325 accumulates the document files exchanged through the collaboration tool. The message DB 330 accumulates messages exchanged through the collaboration tool.

The system coordination module 308 acquires the information element by cooperating with other systems (such as the attendance management system 250, the customer information management system 260, and/or the sales assistance system 270).

The other systems include the sales assistance system 270 that is a core system recording the success/failure of the case, the attendance management system 250 that records the attendance information on a sales person, and the customer information management system 260 that manages information on customers. For example, the customer information management system 260 may be a customer relationship management (CRM) system. The sales assistance system 270 may be a sales force automation (SFA) system.

The information elements itemized, managed and recorded in the other systems may be added as below.

### Example of Newly Added Information Element

The information element “scale of customers” may not be acquired from the document file or the message but may be acquired from another system, such as the CRM system. Example of substitute information element

The information element “case phase” is acquired from the document file or message and is also managed in the SFA system. More accurate case phase may be possibly acquired from the SFA system. In such a case, the information element is not extracted from the document file or message and the information element from the SFA system may be used. Example of accuracy improvement by addition

Concerning the information element “number of contacts with customers”, if in addition to the contents of the information element from the document file or message, out-of-office information is acquired from the attendance management system 250, more accurate number of contacts may be calculated.

If a call by the sales person is so short that the CRM system does not record as a visit, the number of contacts extracted from the document file or the message collection may be extracted. The number of contacts may be more accurate.

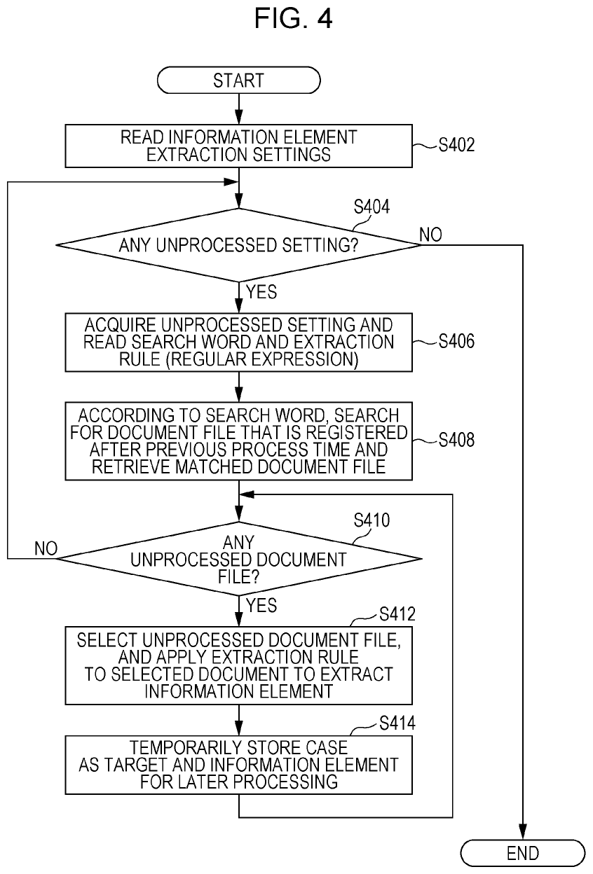

FIG. 4 is a flowchart illustrating a process example (performed by the information extraction module 135) of the exemplary embodiment. The process is performed on the target case in accordance with the flowchart.

In step S402, an information element extraction setting is read. For example, an information element extraction setting management table 900 is read. FIG. 9 illustrates a data structure of the information element extraction setting management table 900. The information element extraction setting management table 900 includes an information element type column 905, search word column 910, and extraction rule column 915. The information element type column 905 stores the type of the information element. The search word column 910 stores a word used in searching to extract the type of the information element. The search word is used to search for the title of the document file or message or search the full text of the document file or message. The extraction rule column 915 stores a rule according to which the type of the information element is extracted. For example, the information element type “number of visits” at the first row of the information element extraction setting management table 900 indicates that the search word is “visit” and the extraction rule is “number of visits. +($d+).” The information element type “competition information” at the second row indicates that the search word is “competition” and the extraction rule is “competitor product (.+).” The extraction rule uses a regular expression. The “number of visits+($d+)” indicates that any given character subsequent to the number of visits is repeated more than once and a number equal to or above 1 is searched for. For example, “number of visits 5” is considered. In this case, “5” is extracted as the information element of the information element type “number of visits.”

In step S404, it is determined whether any unprocessed setting is present. If an unprocessed setting is present, the process proceeds to step S406; otherwise, the process ends (step S499).

In step S406, an unprocessed setting is acquired, a search word and an extraction rule (regular expression) are read. The search word and extraction rule respectively correspond to the search word column 910 and extraction rule column 915 in the information element extraction setting management table 900.

In step S408, a document file registered after a previous process time is searched for according to the search word to find a matched document.

In step S410, a determination is performed to find out an unprocessed document file. If an unprocessed file is found, the process proceeds to step S412; otherwise, the process returns to step S404.

In step S412, an unprocessed document file is selected and an information element is extracted by applying an extraction rule to the unprocessed document file.

In step S414, the target case and the information element are temporarily stored for later process and the process returns to step S410. Specifically, the extracted information element is stored on a per target case basis. The stored information element is used to predict the success/failure of the case.

The flowchart in FIG. 4 illustrates the process to extract the information element from the document file or the message collection. Similarly, the process to extract the information element from a message is performed. Specifically, the term “document file” is simply replaced with the term “message” in the flowchart in FIG. 4.

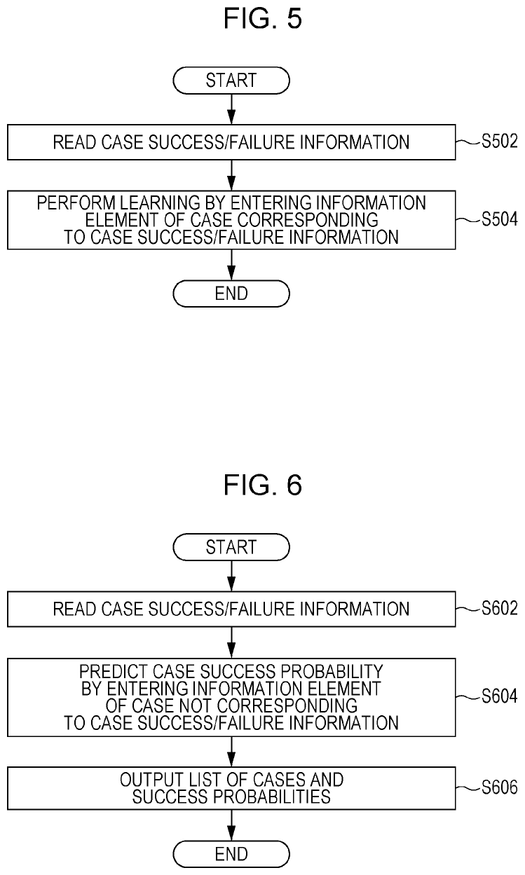

FIG. 5 is a flowchart illustrating a process example (performed by the machine learning module 145) of the exemplary embodiment.

In step S502, the success/failure information for the case is read. Specifically, the success/failure information on the past case whose success or failure is determined is read.

In step S504, the information element of a case corresponding to the success/failure information on the past case are input to perform learning. Specifically, learning is performed in accordance with teacher data that is a set of the success/failure information on the case and the information element of the corresponding case. The information element may be extracted about the target case in accordance with the flowchart in FIG. 4.

FIG. 6 is a flowchart illustrating a process example (performed by the learning model module 140) of the exemplary embodiment.

In step S602, the success/failure information on the case is read.

In step S604, the information element on a case not corresponding to the success/failure information on the case is input to predict the success/failure information on the case. The “target case not corresponding to the success/failure information on the case” is a case whose success or failure is not yet determined.

The operation in step S602 may be an operation to receive a case the conclusion of which is desired to predict and the operation in step S604 may be an operation to predict the case success probability by entering the information element of the case.

In step S606, a list of the cases and success probabilities is output.

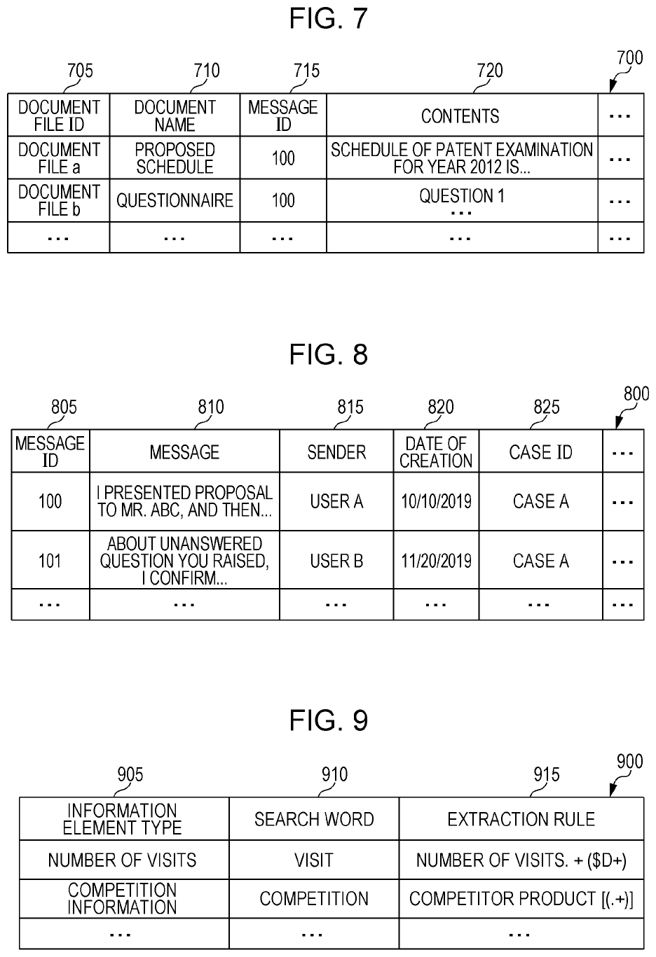

The target case is managed in a document file management table 700. FIG. 7 illustrates a data structure of the document file management table 700. The document file management table 700 includes a document file ID column 705, document name column 710, message ID column 715, and contents column 720. The document file ID column 705 stores information uniquely identifying a document file (specifically, a document file identification (ID)) in the exemplary embodiment. The document name column 710 stores the name of the document file. The message ID column 715 stores uniquely identifying a message (specifically, a message ID) in the exemplary embodiment. For example, the message ID column 715 stores a message ID of the message to which the document file is attached. The contents column 720 stores contents of the document file.

The document file ID “document file a” at the first row of the document file management table 700 indicates that the document file name is “proposed schedule,” the message ID is “100,” the contents are “schedule of patent examination for year 2012 is . . . ” The document file ID “document file b” at the second row of the document file management table 700 indicates that the document file name is “questionnaire,” the message ID is “100,” the contents are “question 1.” Each of the document file a and document file b is a document file attached to message ID: 100.

A case ID column 825 having the value “100” at the message ID column 805 in a message management table 800 is referred to in response to the value “100” at the message ID column 715 in the document file management table 700. The case corresponding to the document file is thus extracted. The document file management table 700 may additionally include a case ID column that associates each document file with each case.

The target case is managed in the message management table 800. FIG. 8 illustrates a data structure of the message management table 800. The message management table 800 includes a message ID column 805, message column 810, sender column 815, date of creation column 820, and case ID column 825. The message ID column 805 stores a message ID. The message column 810 stores the contents of the message. The sender column 815 stores the sender of the message. The date of creation column 820 stores the date (may indicate year, day, hours, and minutes) of creation of the message. The case ID column 825 stores information uniquely identifying the case (specifically, the case ID).

The message ID “100” at the first row of the message management table 800 indicates that the message is “I presented proposal to Mr. ABC and then . . . ,” the sender is “user A,” the date of creation is “10/10/2019” and the case ID is “case A.” The message ID “101” at the second row of the message management table 800 indicates that the message is “About unanswered question you raised, I confirm . . . ,” the sender is “user B,” the date of creation is “11/20/2019” and the case ID is “case A.”

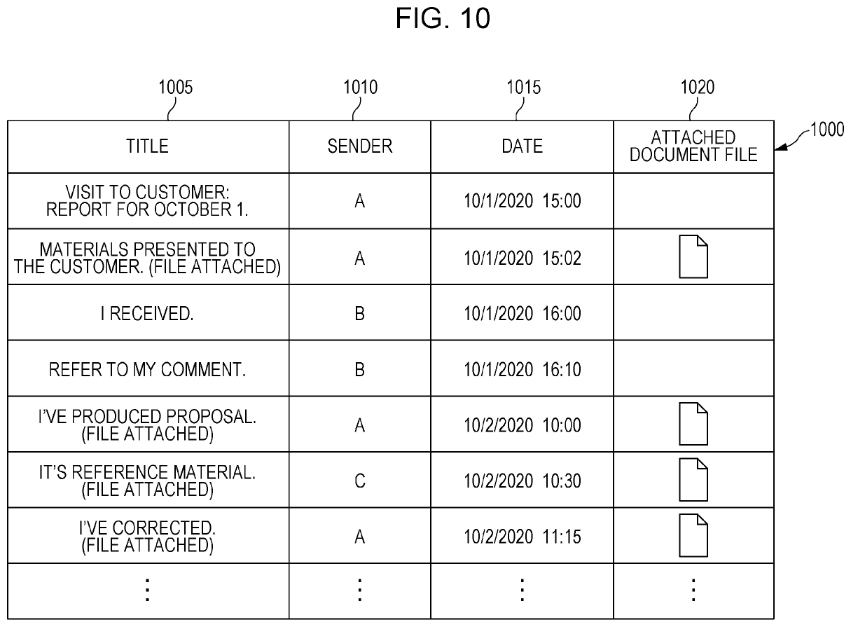

FIG. 10 illustrates a process example of the exemplary embodiment. Through the collaboration tool as a communication tool, a message display screen 1000 is displayed to indicate a message exchange of a case.

The message display screen 1000 displays a title column 1005, sender column 1010, date column 1015, and attached document file column 1020. The title column 1005 displays the title of a message. The sender column 1010 displays the sender of the message. The date column 1015 displays the date on which the message has been posted. The attached document file 1020 display information on the presence of an attached document file.

The title “visit to customer: report for October 1” at the first row of the message display screen 1000 indicates that the sender is “A,” the date is “10/1/2020 15:00,” and the attached document file is “none.”

The title “Materials presented to customer. (File attached)” at the second row indicates that the sender is “A,” the date is “10/1/2020 15:02,” and the attached document file is “present.”

The title “I received.” at the third row indicates that the sender is “B,” the date is “10/1/2020 16:00,” and the attached document file is “none.”

The title “Refer to my comment.” at the fourth row indicates that the sender is “B,” the date is “10/1/2020 16:10,” and the attached document file is “none.”

The title “I've produced proposal. (File attached)” at the fifth row indicates that the sender is “A,” the date is “10/2/2020 10:00,” and the attached document file is “present.”

The title “It's reference material. (File attached)” at the sixth row indicates that the sender is “C,” the date is “10/2/2020 10:30,” and the attached document file is “present.”

The title “I've corrected. (File attached)” at the seventh row indicates that the sender is “A,” the date is “10/2/2020 11:15,” and the attached document file is “present.”

When the messages are exchanged as illustrated in FIG. 10, the message collection is divided into a series of exchanges. The exchange result may be managed as in a message group management table 1100.

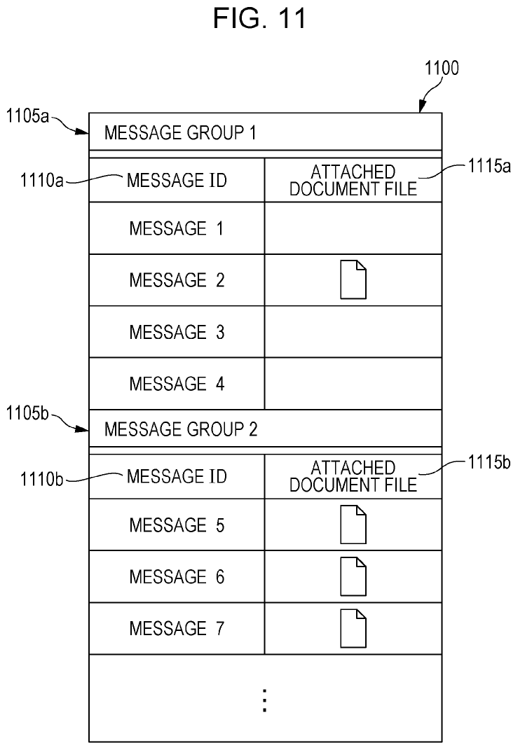

FIG. 11 illustrates a data structure of the message group management table 1100. The message group management table 1100 includes group ID columns 1105a and 1105b. Each group ID column 1105 includes a message ID column 1110 and an attached document file column 1115.

A message group 1 includes messages 1 through 4 and a message group 2 indicates the presence of an attached document file.

A message group 2 includes messages 5 through 7 and indicates that messages 5, 6, and 7 are attached with document files.

A message n corresponds to a row n of the message display screen 1000 in FIG. 10.

Multiple messages posted for a given case are sorted into the message group 1 and the message group 2 according to the date of posting of each message.

For example, a series of exchanges of messages is performed concerning a subject through chat type collaboration tool. The series of exchanges includes multiple messages and document files attached thereto. In this case, messages continually posted are determined to be related to the same subject. If a message is posted within a predetermined period of time from an immediately preceding message, the two messages are determined to be in the same group. In this way, messages are grouped. Referring to FIG. 11, the grouping is performed with a predetermined period of time of 1 hour. Specifically, the messages 1 through 4 are posted within 1 hour, the messages 5 through 7 are posted within 1 hour, and a time interval between the messages 4 and 5 is longer than 1 hour. The grouping is thus performed as illustrated in FIG. 11.

If the message “Visit to customer: Report for October 1” or “Materials presented to the customer. (File attached)” is posted and the attached file as the case studying and introduction material does not specify the date of the visit, the October 1 visit is known from the preceding message belonging to the same group. Specifically, even if the information element is not extracted from the document file using the information element extraction setting management table 900, the information element may be extracted by referring to the message group (a single message collection grouped) in the series of exchanges of groups.

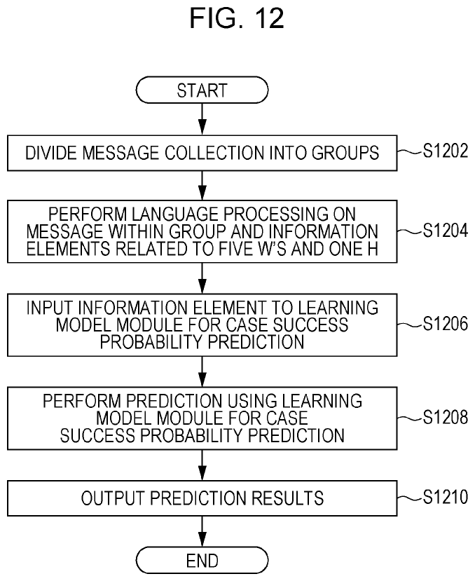

FIG. 12 is a flowchart illustrating a process example of the exemplary embodiment.

In step S1202, the message collection is grouped.

In step S1204, language processing is performed on a message within a group and the six information elements of five W's and one H. Two or more information elements are extracted.

In step S1206, an information element is input to the learning model module 340 for case success probability prediction. In this case, the extracted information elements of five W's and one H extracted in step S1204 are input in an associated form to the learning model module 340 for case success probability prediction.

In step S1208, the learning model module 340 for case success probability prediction performs prediction.

In step S1210, prediction results are output.

After the operations in steps S1202 through S1206, machine learning is performed based on the teacher data that is a set of information elements five W's and one H and conclusion.

A process example of selecting the information elements to be input to the learning model module 140 is described using the prediction accuracy corresponding to the extracted information element. A narrowing operation performed by the information element narrowing module 310 is described below.

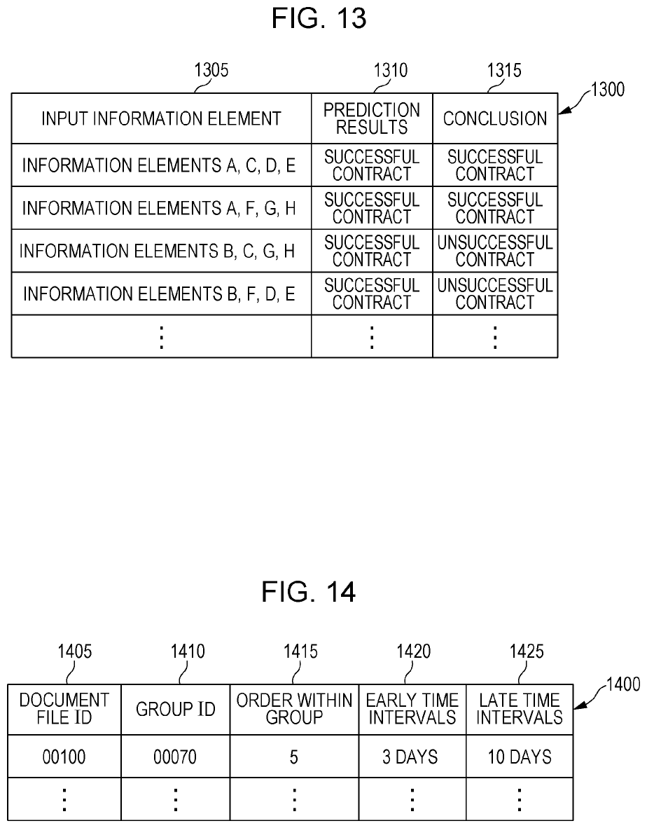

FIG. 13 illustrates a data structure of a prediction and conclusion management table 1300. The prediction and conclusion management table 1300 includes an input information element column 1305, prediction results column 1310, and conclusion column 1315. The input information element column 1305 stores an information element input to the learning model module 140. The prediction results column 1310 stores prediction results provided by the learning model module 140. The conclusion column 1315 stores the actual conclusion of the case.

The input information elements “Information elements A, C, D, and E” at the first row of the prediction and conclusion management table 1300 indicate that the prediction results are “successful contract” and the conclusion is “successful contract.” The input information elements “Information elements A, F, G, and H” at the second row indicate that the prediction results are “successful contract” and the conclusion is “successful contract.” The input information elements “Information elements B, C, G, and H” at the third row indicate that the prediction results are “successful contract” and the conclusion is “unsuccessful contract.” The input information elements “Information elements A, F, D, and E” at the fourth row indicate that the prediction results are “successful contract” and the conclusion is “unsuccessful contract.” The different alphabet information elements indicate different information element types.

The cases having the prediction results of the learning model module 140 different from the actual conclusion (e.g., the prediction results indicate a successful contract but the conclusion is an unsuccessful contract or conversely, or the prediction results indicate an unsuccessful contract but the conclusion is a successful contract) may now be collected. Among the information elements used to predict the conclusion of each case, commonly used information elements are not used. Referring to FIG. 13, the information element commonly used to the third and fourth rows is the information element B. At next prediction, the information element type corresponding to the information element B is not used. For example, the information element is a value “5 (times)” at the number of contacts with customers. This does not mean that the value “5 (times)” is not used in the narrowing operation but means that the number of contacts with customers is not used because the number of contacts with customers does not contribute to the success/failure information on the case.

The prediction results by the learning model module 140 matches the actual conclusion (e.g., the prediction results indicate a successful contract but the conclusion is a successful contract or, conversely, the prediction results indicate an unsuccessful contract but the conclusion is an unsuccessful contract) may now be collected. Among the information elements used to predict the conclusion of each case, commonly used information elements are not deleted. Referring to FIG. 13, the information element commonly used to the first and second rows is the information element A. At next prediction, the information element type corresponding to the information element A is not deleted. Specifically, an information element may become a deletion target when the prediction results by the learning model module 140 are different from the actual conclusion. In this case, as long as that information element is commonly used when the prediction results by the learning model module 140 matches the actual conclusion, the information element is no longer a deletion target.

The sequential order or time intervals at which the extracted information has been provided to the customer are described. The time intervals of the provided document files may be longer because the response from the customer is slower. In that case, the customer interest in the product may not probably be so high. If the quote for the product is provided earlier, the customer interest may probably be higher.

FIG. 14 illustrates a data structure of a document file order management table 1400. The document file order management table 1400 includes a document file ID column 1405, group ID column 1410, order within group column 1415, early time interval column 1420, and late time interval column 1425. The document file ID column 1405 stores a document file ID. The group ID column 1410 stores a group ID. The order within group column 1415 stores a sequential order within the group. The early time interval column 1420 stores an early time interval. The late time interval column 1425 stores a late time interval.

With the messages grouped, the document file order management table 1400 indicates the sequential order of generation of a document file attached to each message within a group and time intervals of documents generated prior to and subsequent to that message within the group.

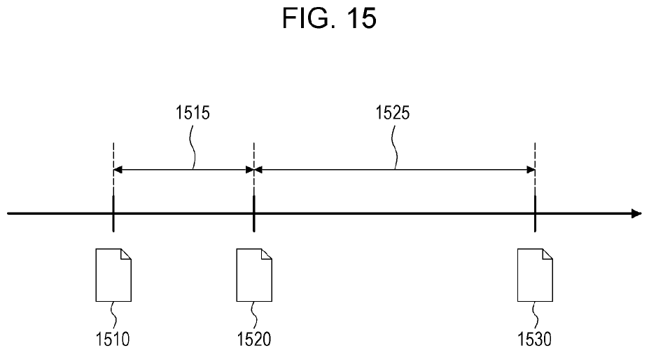

For example, referring to FIG. 15, the first row of the document file order management table 1400 indicates that a document file ID “00100” (a document file 1520) belongs to a group ID “0070,” the order of generation of the document file within the group is 5th, an early time interval with a document file 1510 generated earlier (early time interval 1515) is 3 days, and a late time interval with a document file 1530 (late time interval 1525) is 10 days.

The extracted information and the sequential order or time intervals are input in an associated form to the learning model module 140 for prediction.

The machine learning is naturally performed using the teacher data. The teacher data is created by extracting the sequential order or time intervals of the information element within the group and by associating the extracted information with the sequential order or time intervals.

The use of the document file has been described. The sequential order or time intervals of the message provided to the customer may be also be used.

An information element extraction setting management table 1600 may be used instead of the information element extraction setting management table 900.

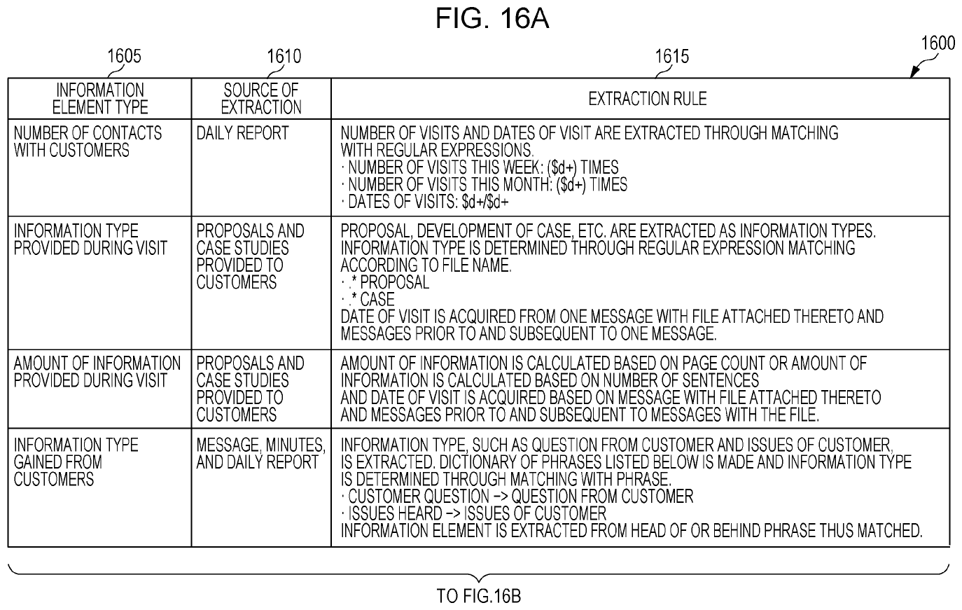

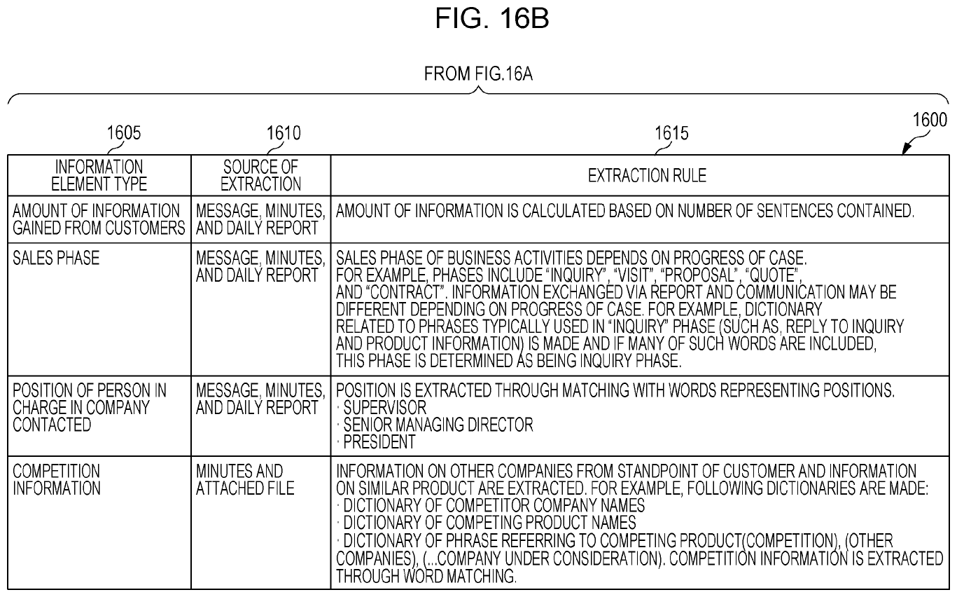

FIGS. 16A and 16B illustrate a data structure of the information element extraction setting management table 1600. The information element extraction setting management table 1600 includes an information element type column 1605, source of extraction column 1610, and extraction rule column 1615. The information element type column 1605 stores an information element type. The source of extraction column 1610 stores a source of extraction. The extraction rule column 1615 stores an extraction rule.

The first row of the information element extraction setting management table 1600 indicates that the information element type is the “Number of contacts with customers,” a source of extraction is “Daily report,” an extraction rule is “The number of visits and dates of visits are extracted through matching with a regular expression. The following regular expressions are used:

Number of visits this week: ($d+) times,

Number of visits this month: ($d+) times, and

Dates of visits: $d+/$d+”.

The second row indicates that the information element type is “Information type provided during visit,” the source of extraction is “Proposals and case studies provided to customers,” the extraction rule is “Proposal, development of case, etc. are extracted as information type. Type of provided information is determined through regular expression matching according to file name. The following regular expressions are used:
proposal, and
case study
   Date of visit is acquired from one message with file attached and messages prior to and subsequent to that message.”

The third row indicates that the information element type is “Amount of information provided during visit,” the source of extraction is “Proposals and case studies provided to customers,” the extraction rule is “Amount of information is calculated based on page count or amount of information is calculated based on number of sentences, and the date of visit is acquired based on a message with file attached thereto and messages prior to and subsequent to the message.”

The fourth row indicates that the information element type is “Information type gained from customers,” the source of extraction is “Message, minutes, and daily report,” the extraction rule is “Information type, such as question from customer and issues of customer, is extracted. Dictionary of phrases listed below is made and information type is determined through matching with phrases as follows:

Customer question->question from customer, and

Issues heard->issues of customer.

Information element is extracted from ahead of or behind phrase thus matched.”

The fifth row indicates that the information element type is “Amount of information gained from customers,” the source of extraction is “Message, minutes, and daily report,” the extraction rule is “Amount of information is calculated based on number of sentences contained.”

The sixth row indicates that the information element type is “Sales phase,” the source of extraction is “Message, minutes, and daily report proposals,” the extraction rule is “Sales phase of business activities depends on progress of case. For example, phases include “Inquiry,” “visit,” “proposal,” “quote,” and “contract.” Information exchanged via report and communication may be different depending on progress of case. For example, dictionary related to phrases typically used at “inquiry” phase (such as, reply to inquiry and product information) is made and if many of such words are included, this phase is determined as being inquiry phase.”

The seventh row indicates that the information element type is “Position of person in charge in company contacted.” the source of extraction is “Message, minutes, and daily,” the extraction rule is “Position is extracted through matching with words representing positions:

Supervisor,

Senior managing director, and

President.”

The eighth row indicates that the information element type is “Competition information,” the source of extraction is “Minutes, and attached file,” the extraction rule is “Information on other companies from standpoint of customer and information on similar product are extracted. For example, following dictionaries are made:

Dictionary of competitor company names,

Dictionary of competing product names, and

Dictionary of phrase referring to competing product including “competition” “other companies,” “ . . . company under consideration.” Competition information is extracted through word matching.”

The program described above may be provided in the recorded form on a recording medium or via a communication medium. The program described above may be construed as a computer readable non-transitory recording medium storing the program.

The computer readable non-transitory recording medium refers to as a recording medium that is used to install, execute, and/or distribute the program.

The recording media include digital versatile disk (DVD), compact disk (CD), Blu-ray disc (registered trademark), magnetooptical disk (MO), flexible disk (FD), magnetic tape, hard disk, read-only memory (ROM), electronically erasable and programmable read-only memory (EEPROM (registered trademark)), flash memory, random-access memory (RAM), and secure digital (SD) memory card. The DVDs include “DVD-R, DVD-RW, and DVD-RAM” complying with the standard formulated by the DVD forum, and “DVD+R and DVD+RW” complying with DVD+RW standards. The CDs include read-only CD (CD-ROM), recordable CD-R, and rewritable CD-RW.

The program in whole or in part may be stored on the recording medium for storage and distribution. The program in whole or in part may be transmitted via a transmission medium. The transmission media include a wired network, a wireless network, or a combination thereof. The wired and wireless networks may include a local-area network (LAN), metropolitan-area network (MAN), wide-area network (WAN), the Internet, intranet, and/or extranet. The program in whole or in part may be transmitted over a carrier wave.

The program may be part or whole of another program, or may be stored on the recording medium together with another program. The program may be split and the split programs may then be separately stored on the recording media. The program may be processed in any fashion before being stored as long as the program remains restorable. For example, the program may be compressed or encrypted before storage.

In the exemplary embodiment above, the term “processor” refers to hardware in a broad sense. Examples of the processor include general processors (e.g., CPU: Central Processing Unit), and dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a memory storing a document file created for cases or a message collection related to the cases and exchanged among a plurality users; and
a processor configured to
extract information on a target case from the document file or the message collection stored on the memory, and
predict a conclusion of the target case from the extracted information using artificial intelligence that has learned through machine learning to predict the conclusion of the target case in accordance with information in the document file or the message collection on each case.

2. The information processing apparatus according to claim 1, wherein the memory stores the message collection and
wherein the processor is configured to divide the message collection into a series of exchanges of messages and extract the information on the target case for each of the exchanges.

3. The information processing apparatus according to claim 2, wherein the processor is configured to use the artificial intelligence by linking at least two pieces of information of “when”, “where”, “who”, “what”, “why”, and “how” as the information to be extracted from the series of the exchanges.

4. The information processing apparatus according to claim 1, wherein the processor is configured to
extract a plurality of different types of information in accordance with a plurality of different rules, and
select, using a prediction accuracy responsive to each of the extracted types of information, a type of information to be used by the artificial intelligence.

5. The information processing apparatus according to claim 2, wherein the processor is configured to
extract a plurality of different types of information in accordance with a plurality of different rules, and
select, using a prediction accuracy responsive to each of the extracted types of information, a type of information to be used by the artificial intelligence.

6. The information processing apparatus according to claim 3, wherein the processor is configured to
extract a plurality of different types of information in accordance with a plurality of different rules, and
select, using a prediction accuracy responsive to each of the extracted types of information, a type of information to be used by the artificial intelligence.

7. The information processing apparatus according to claim 1, wherein the processor is configured to
retrieve, from an external information processing apparatus, second information related to the extracted information, and
predict, by associating the extracted information with the second information, the conclusion of the target case using the artificial intelligence.

8. The information processing apparatus according to claim 2, wherein the processor is configured to
retrieve, from an external information processing apparatus, second information related to the extracted information, and
predict, by associating the extracted information with the second information, the conclusion of the target case using the artificial intelligence.

9. The information processing apparatus according to claim 3, wherein the processor is configured to
retrieve, from an external information processing apparatus, second information related to the extracted information, and
predict, by associating the extracted information with the second information, the conclusion of the target case using the artificial intelligence.

10. The information processing apparatus according to claim 4, wherein the processor is configured to
retrieve, from an external information processing apparatus, second information related to the extracted information, and
predict, by associating the extracted information with the second information, the conclusion of the target case using the artificial intelligence.

11. The information processing apparatus according to claim 5, wherein the processor is configured to
retrieve, from an external information processing apparatus, second information related to the extracted information, and
predict, by associating the extracted information with the second information, the conclusion of the target case using the artificial intelligence.

12. The information processing apparatus according to claim 6, wherein the processor is configured to
retrieve, from an external information processing apparatus, second information related to the extracted information, and
predict, by associating the extracted information with the second information, the conclusion of the target case using the artificial intelligence.

13. The information processing apparatus according to claim 1, wherein the processor is configured to
extract a sequential order or time intervals at which the extracted information has been provided to a partner user, and
predict, by associating the extracted information with the sequential order or the time intervals, the conclusion of the target case using the artificial intelligence.

14. The information processing apparatus according to claim 2, wherein the processor is configured to
extract a sequential order or time intervals at which the extracted information has been provided to a partner user, and
predict, by associating the extracted information with the sequential order or the time intervals, the conclusion of the target case using the artificial intelligence.

15. The information processing apparatus according to claim 3, wherein the processor is configured to
extract a sequential order or time intervals at which the extracted information has been provided to a partner user, and
predict, by associating the extracted information with the sequential order or the time intervals, the conclusion of the target case using the artificial intelligence.

16. The information processing apparatus according to claim 4, wherein the processor is configured to
extract a sequential order or time intervals at which the extracted information has been provided to a partner user, and
predict, by associating the extracted information with the sequential order or the time intervals, the conclusion of the target case using the artificial intelligence.

17. The information processing apparatus according to claim 5, wherein the processor is configured to
extract a sequential order or time intervals at which the extracted information has been provided to a partner user, and
predict, by associating the extracted information with the sequential order or the time intervals, the conclusion of the target case using the artificial intelligence.

18. The information processing apparatus according to claim 6, wherein the processor is configured to
extract a sequential order or time intervals at which the extracted information has been provided to a partner user, and
predict, by associating the extracted information with the sequential order or the time intervals, the conclusion of the target case using the artificial intelligence.

19. A non-transitory computer readable medium storing a program causing a computer to execute a process for processing information, the process comprising:
storing a document file created for cases or a message collection related to the cases and exchanged among a plurality users on a memory;
extracting information on a target case from the document file or the message collection stored on the memory; and
predicting a conclusion of the target case from the extracted information using artificial intelligence that has learned through machine learning to predict the conclusion of the target case in accordance with information in the document file or the message collection on each case.

20. An information processing apparatus comprising:
a memory for storing a document file created for cases or a message collection related to the cases and exchanged among a plurality users; and
means for extracting information on a target case from the document file or the message collection stored on the memory, and
means for predicting a conclusion of the target case from the extracted information using artificial intelligence that has learned through machine learning to predict the conclusion of the target case in accordance with information in the document file or the message collection on each case.
